(19) United States
(12) Patent Application Publication
(10) Pub. No.: US 2024/0383666 A1
(43) Pub. Date: Nov. 21, 2024

(54) DISPENSER DEVICE FOR LIQUIDS IN CONTAINER BAG

(71) Applicant: SMAOINTE NUA Limited, Dublin (IE)

(72) Inventor: Marek SZYMANSKI, Warrington Mall, New South Wales (AU)

(21) Appl. No.: 18/718,025

(22) PCT Filed: Dec. 9, 2022
(86) PCT No.: PCT/AU2022/051486

§ 371 Date: Jun. 8, 2024

(30) Foreign Application Priority Data
Dec. 9, 2021 (AU) 2021903986

(51) Int. Cl. B65D 83/00

(52) U.S. Cl. CPC B65D 83/0055

(57) ABSTRACT

A dispensing device includes a base with an upright support holding a ram assembly and a liquid container bag support. The bag support holds a liquid container bag with an outlet portion thereof supported below the ram assembly. The ram assembly is disposed within a housing having a left wall, a right wall and an open lower portion. The bag support is disposed along an external surface of the left wall. The ram assembly includes a squeezer element mounted to a ram. The ram is moved in the vertical axis in a linear reciprocating motion. Rotation of the shaft of the motor translates to movement of the ram up and down in a reciprocating manner moving the squeezer element therewith.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a dispenser device for liquids in a container bag.

### 2. Description of Related Art Including Information Disclosed Under 37 CFR 1.97 and 37 CFR 1.98

In hotels and restaurants and other catering settings, providing bottles of sauces, honey, syrup, liquid chocolate, liquid caramel, and the like to customers typically results in wastage, drips and mess and no portion control. Another option is portion control using pre-packaged small/single portions via single use typically plastic containers. This, however, results in product wastage and plastic pollution.

The present invention can also be used for non-food products in industrial applications for dispensing portions of other liquids such as soaps, detergents, cleaning products, grease, oil and other industrial liquids or semi-liquids.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a dispensing device for a liquid container bag having an outlet portion with an outlet spout, the device comprising:
a ram assembly with a squeezer element for applying a squeezing force to the outlet portion to dispense liquid via the outlet spout.

In a preferred embodiment, the squeezer element comprises a cut-off portion which presses against a section of the container bag when the squeezer element starts to apply the squeezing force to cut off liquid in the outlet portion from the remainder of the container bag. In the embodiment described below, the cut-off portion cuts off liquids in an outlet portion from a main portion of the container bag.

In another preferred embodiment, the squeezer element has an angled face and the cut-off portion comprises a wedge formation defined by the angled face. In the embodiment described below, the wedge formation is defined by the common line between a side wall and an angled lower surface of the squeezer element.

In another preferred embodiment, the squeezer element applies the squeezing force in a direction from the cut-off portion towards the outlet spout as the squeezer element applies the squeezing force. In the embodiment described below, the squeezer element is resilient and has an angled lower surface which applies the squeezing force in the desired direction.

In another preferred embodiment, the device comprises a support tray for supporting the outlet portion, the support tray having an aperture for the outlet spout, and the squeezer element presses against the outlet portion in the support tray.

In another preferred embodiment, the support tray is horizontal and the ram is adapted to be moved in the vertical axis in a linear motion such that the squeezer element presses down on the outlet portion.

In another preferred embodiment, the ram is movable via an actuator in a reciprocating manner along the vertical axis.

In another preferred embodiment, the actuator is a motor connected to the ram via an offset crankshaft link and a connecting rod such that one rotation of the motor translates to movement of the ram from an initial up position, down to a squeezing position, and back up to the initial up position.

In another preferred embodiment, the squeezer element is made from a soft resilient material which can deform when force is applied thereto but will return to its original shape when the force is removed.

In another preferred embodiment, the squeezer element is shaped as a block body having an upper portion, a lower surface, a left side wall, and a right side wall, and the upper portion comprises a rigid plate which is adapted for quick connection to the ram.

In another preferred embodiment, the lower surface angled upwardly relative to the upper portion.

In another preferred embodiment, the outlet portion comprises a lower layer and an upper layer each having a connection means, and the squeezer element comprises a corresponding connection means for connecting to the upper layer, and the support tray comprises a corresponding connection means for connecting to the lower layer.

In another preferred embodiment, the device comprises mounting hooks for supporting the bag in a generally vertical orientation.

In another preferred embodiment, the support tray is pivotable from lowered angled position to a horizontal support position.

In another preferred embodiment, the device comprise a horizontal ledge having a lower surface which will engage an upper layer of the outlet portion of the container bag, the ledge and the support tray clamping a distal end of the outlet portion therebetween in use.

In another preferred embodiment, the device includes a latch for locking the support tray in the support position.

In another preferred embodiment, the position of the squeezer element relative to the outlet portion is adjustable for adjusting the quantity of liquid to be expelled from the outlet portion.

In another preferred embodiment, the position of the squeezer element relative to the ram is adjustable.

In another preferred embodiment, the travel distance of the ram assembly is adjustable for adjusting the squeezing force applied to the outlet portion and the amount of liquid dispensed via the outlet spout.

In another preferred embodiment, the device comprises a selection means for allowing the user to select the desired amount of liquid to be dispensed.

In another preferred embodiment, the dispensing device further comprises a contactless sensor for initiating the movement of the ram assembly.

In another preferred embodiment, the sensor is disposed underneath the support tray such that when a container is detected under the spout, movement of the ram is initiated.

The invention also provides an assembly comprising:
a dispensing device according to the above, and
a container bag having a main portion and an extension outlet portion extending from a lower end of the main portion, the outlet portion being a narrower extension of the main portion.

In another preferred embodiment, the dispenser bag in structure comprises two plastic layer sheets sealed at their edges, and a lower edge of the main portion is angled towards the outlet portion for directing the liquid to the outlet portion in use.

In another preferred embodiment, the outlet portion comprises an outlet spout at the lower layer thereof and a connection means at the upper layer thereof and a lower connection means at the lower layer thereof.

In another preferred embodiment, the outlet spout has a one way valve therein to allow one way dispensing of liquid from the container bag and prevent air or other contaminants from entering.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a front perspective view of a dispenser assembly in accordance with a preferred embodiment of the present invention, with a support tray of the assembly in the lowered loading position thereof.

FIG. 2 is a front elevation view of the assembly of FIG. 1.

FIG. 3 is a front elevation view of the assembly of FIG. 1 with the support tray in the raised engaged position.

FIG. 4 is a bottom perspective view of the assembly of FIG. 1.

FIGS. 5 to 7 show schematic views of the steps of loading of a liquid container bag to the dispenser assembly.

FIGS. 6 to 9 shows schematic views of the steps of the squeezer element pressing on the liquid container bag to dispense the desired amount of liquid.

FIG. 10 shows a schematic view of the liquid container bag where (a) is a bottom layer view, (b) is a side view, (c) is a bottom perspective view.

FIG. 11 shows the liquid container bag where (a) is a top layer view, (b) is a side view, (c) is a top perspective view.

FIG. 12 is a perspective view of the assembly with a front cover.

FIG. 13 is a perspective view of the assembly with a front cover and manual handle actuator for the ram assembly.

### DETAILED DESCRIPTION OF THE INVENTION

It should be noted in the following description that like or the same reference numerals in different embodiments denote the same or similar features.

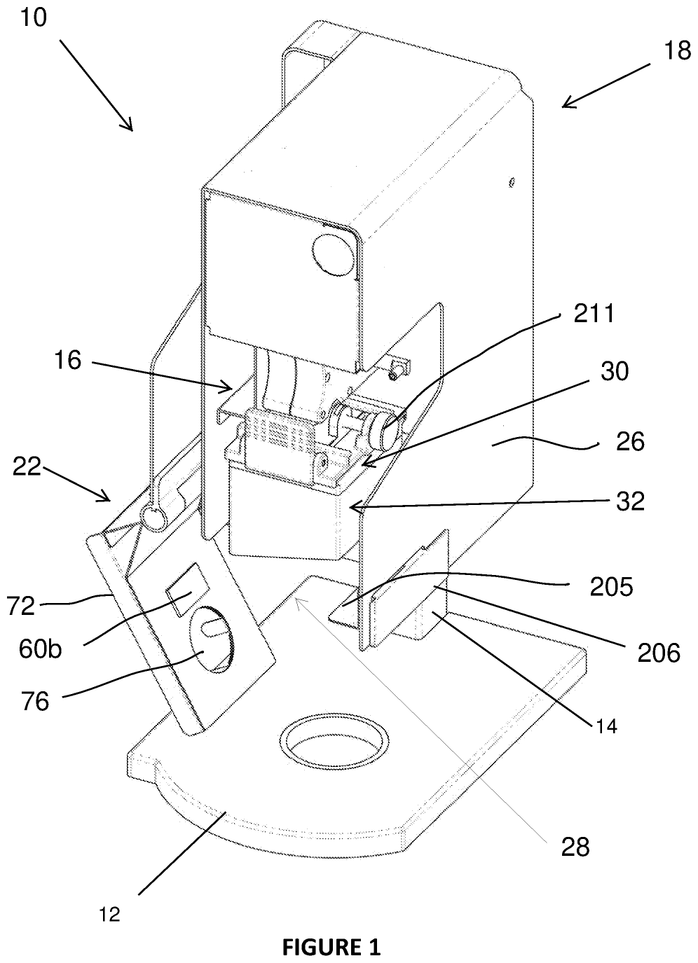

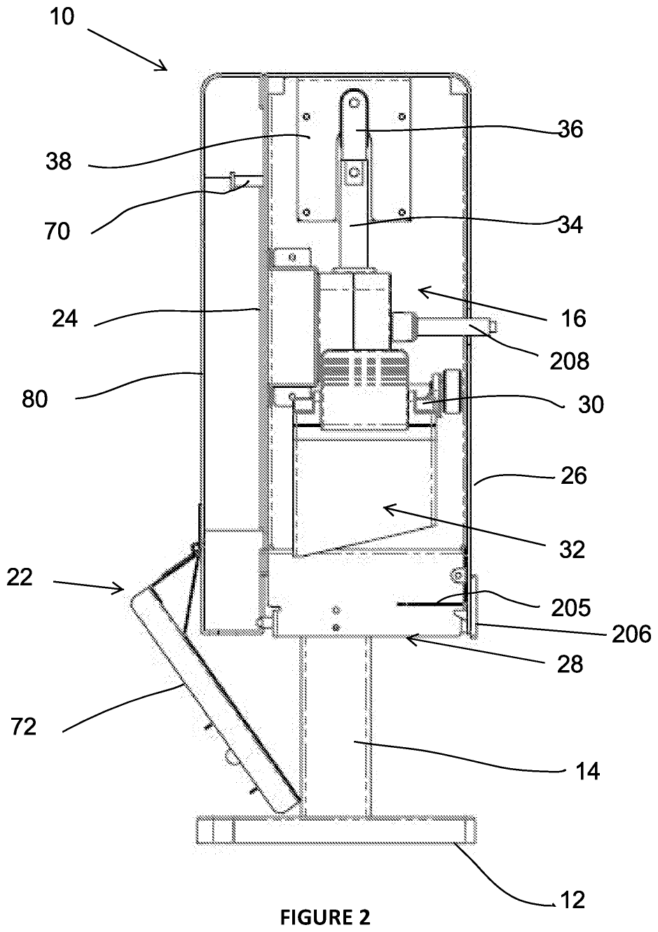

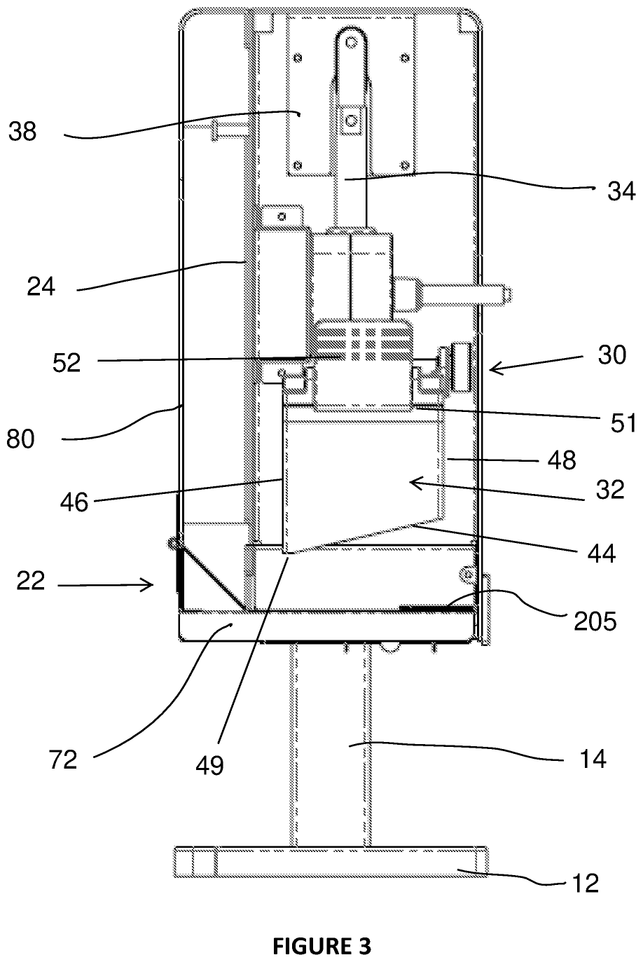

FIGS. 1 to 4 show a dispensing device 10 according to a preferred environment of the present invention. The dispensing device 10 comprises a base 12 with an upright support 14 holding a ram assembly 16 and a liquid container bag support 22. The bag support 22 holds a liquid container bag 20 with an outlet portion 94 thereof supported below the ram assembly 16.

The ram assembly 16 is disposed within a housing 18 having a left wall 24, a right wall 26 and an open lower portion 28. The bag support 22 is disposed along an external surface of the left wall 24.

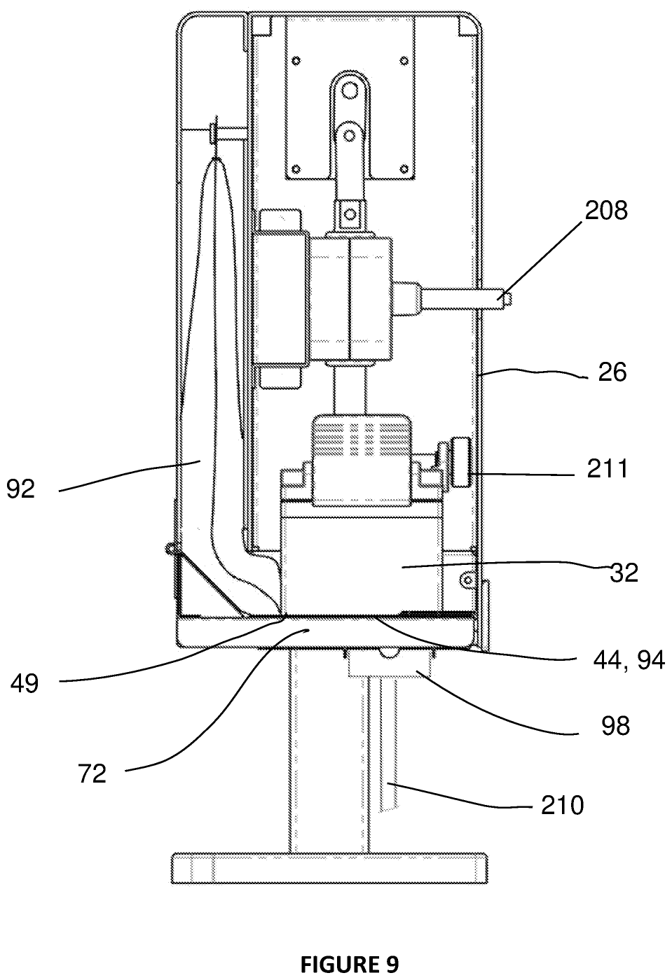

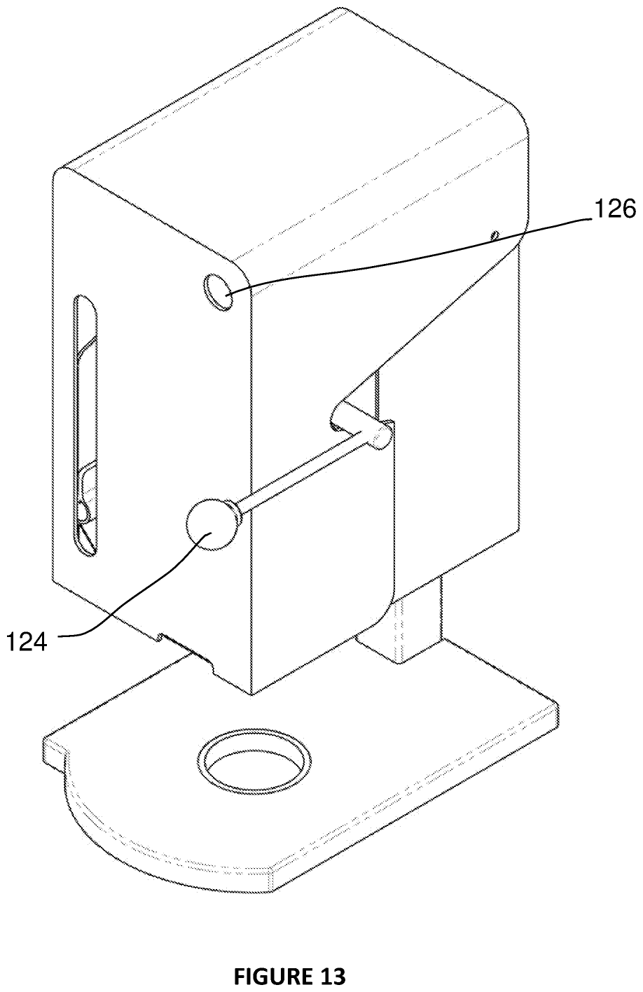

The ram assembly 16 comprises a squeezer element 32 mounted to a ram 30. The ram 30 is moved in the vertical axis in a linear reciprocating motion. That is, the ram 30 with the squeezer element 32 mounted to extend downwardly therefrom is moved up and down along a straight line in a reciprocating manner. The ram 30 includes an upper connecting rod 34 which is connected via offset crankshaft links 36 to a shaft of the motor 38. Rotation of the shaft of the motor 38 translates to movement of the ram 30 up and down in a reciprocating manner moving the squeezer element 32 therewith. It is to be noted the ram 30 can be provided with its linear reciprocating motion by other means such as linear actuators, pneumatic cylinder, hydraulic cylinder, other suitable actuator, or by manual means such as handle 124 (FIG. 13) attached to spindle 208 (FIG. 9) acting as a rack and pinion assembly with the connecting rod 34.

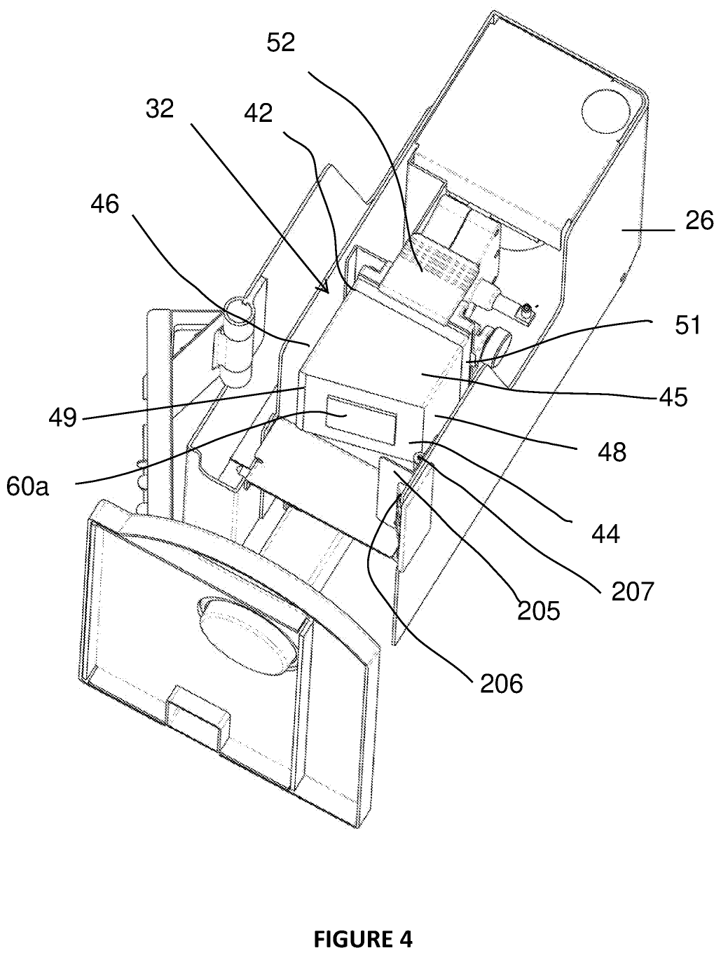

The squeezer element 32 is made from a soft resilient material such as silicone, foam or latex. The squeezer element 32 is resilient in that it will deform when force is applied thereto but will return to its original shape when the force is removed. The squeezer element 32 is shaped as a block body having an upper portion 42, a lower surface 44, a front wall 45, a left side wall 46, a right side wall 48 and a rear wall. The upper portion 42 comprises a rigid plate 51 which is adapted for quick connection to the ram 30. As shown in FIG. 4, the ram 30 includes a clip 52 for quick attachment of the plate 51 and thus the squeezer element 32 thereto.

The lower surface 44 is formed at an upward angle relative to the upper portion 42. That is, the lower surface 44 is angled upwardly from the left side wall 46 to the right side wall 48. The right side wall 48 thus has a shorter depth then the left side wall 46. The angle of the lower surface 44 relative to the horizontal is between 15 to 45 degrees. The left side wall 46 and the lower surface 44 form a pointed junction line 49 therebetween.

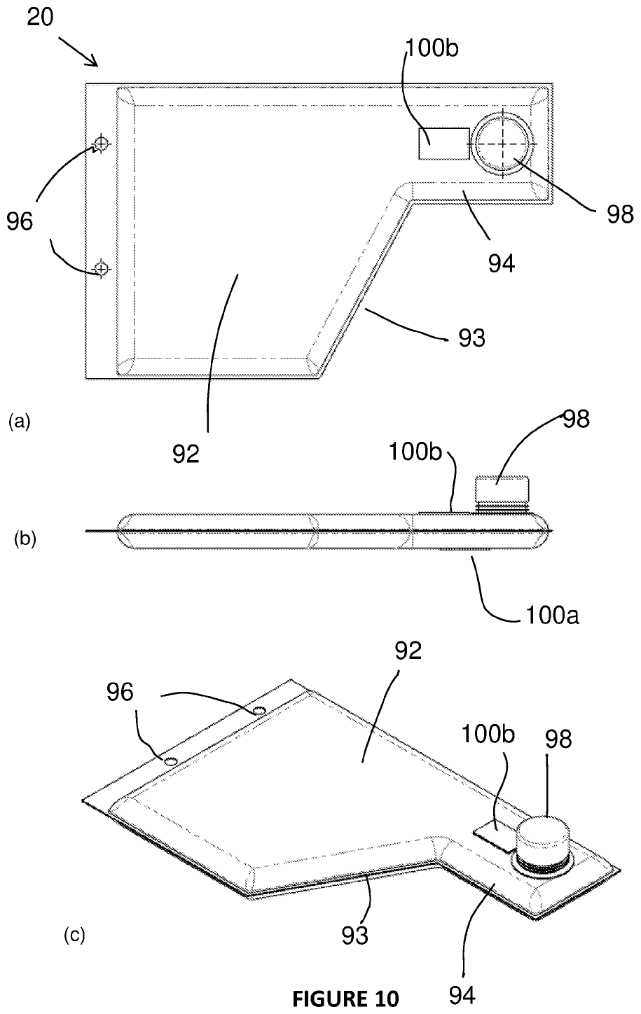

A bag connection means 60a is mounted to the squeezer element 32, the bag connection means in this embodiment being a hook patch 60a in the lower surface 44. The hook patch 60a in the lower surface 44 is for detachable attachment to the connection patch 100a of the outlet portion 94 of the container bag 20 as described below (FIG. 10).

The bag support 22 comprises mounting hooks 70 disposed on the upper portion of the left wall 24, and a pivotable support tray 72 which is to extend across the open lower portion 28 of the housing 18 to be positioned below the squeezer element 32. The support tray 72 is pivotable between a disengaged position at which it extends downwardly and away from the open lower portion 28, to an engaged horizontal position at which it is locked to extend across the open lower portion 28. The support tray 72 comprises an aperture 76 which is adapted to receive an outlet spout 98 of the container bag 20. The support tray 72 additionally includes a connection patch 60b which is for detachable attachment to the connection patch 100b of the container bag 20.

Extending inwardly from the right wall 26 of the housing 18 is a horizontal ledge 205 which has a lower surface which will engage an upper layer of the outlet portion 94 of the container bag 20. The ledge 205 in use acts as one side of a clamp, with the other side of the clamp being the support tray 72.

In the embodiment, the assembly 10 includes an external side cover panel 80 for partly covering the container bag 20, the side cover panel 80 being disposed to be parallel to the left wall 24. The support tray 72 is pivotably attached to a lower edge of the cover panel 80. The support tray 72 however can be attached in a different manner to be located across the open lower portion 28. The support tray for example can be pivotably attached to the right wall 26 instead.

The right wall 26 additionally includes a latch 206 which is hingedly attached at 207 to the right wall 26. The latch 206 is located below the ledge 205 and is biased to engage the distal end of the support tray 72, with the latch 206 pivoting outwardly momentarily for the distal end of the support tray 72 to pass then moving back to position to engage a lower surface of the support tray 72.

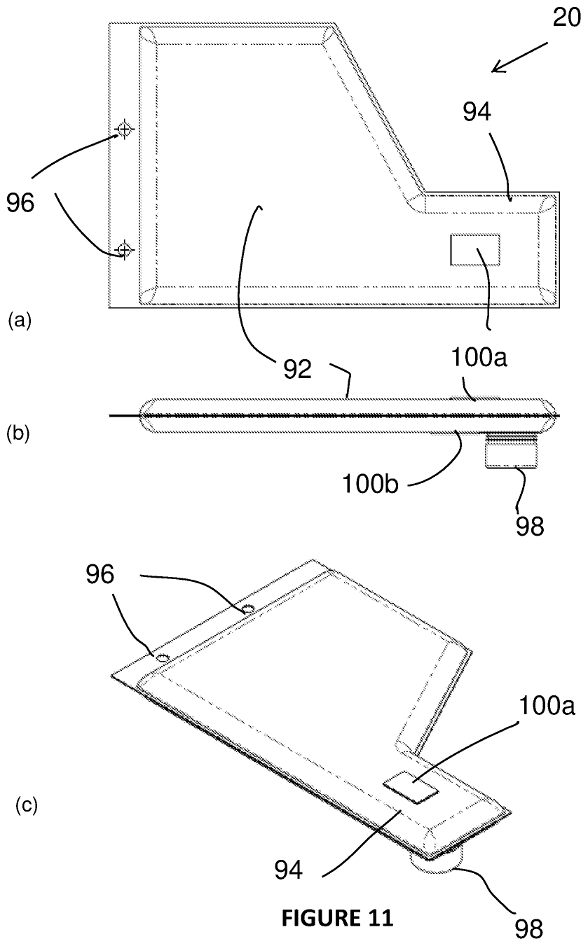

Referring to FIGS. 10 and 11, the container bag 20 comprises a main portion 92 and an extension outlet portion 94 extending from a lower end of the main portion 92. The dispenser bag in structure essentially comprises two plastic layer sheets (upper layer and lower layer) sealed at their edges, and comprises mount apertures 96 at a top edge thereof for mounting to the mounting hooks 70 of the bag support 22. The outlet portion 94 is a narrower extension of the main portion 92 and is disposed adjacent a side edge of the container bag 20, with a lower 93 edge of the main portion 92 being angled towards the outlet portion 94 for directing the liquid to the outlet portion 94 in use when the main portion 92 is mounted in the vertical position. The outlet portion 94 comprises an outlet spout 98 at a lower layer thereof and a connection means 100a at an upper layer thereof and connection means 100b at a lower layer thereof. The outlet spout 98 has a one way valve therein to allow one way dispensing of liquid from the container bag 20 and prevent air or other contaminants from entering. The valve also prevents the flow of the liquid from the spout 98 when the bag 20 is not under pressure. The connection means 100 are loop patches 100 for attachment to the hook patch 60a in the lower surface 44 of the squeezer element 32 and to the hook patch 60b in the support tray 72.

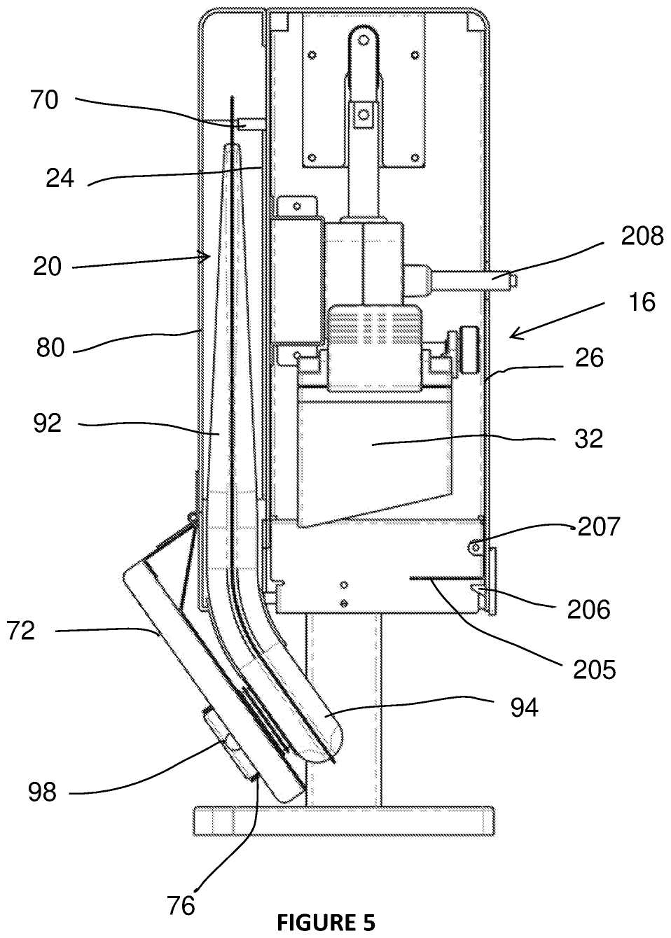

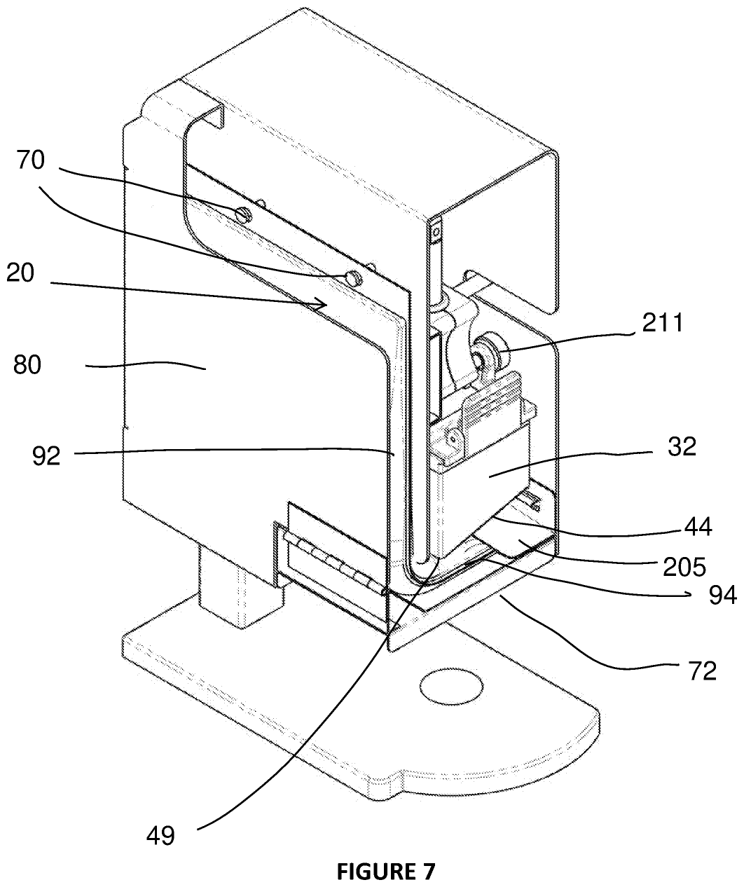

Loading of the container bag 20 to the assembly 10 is shown in FIGS. 5 to 7. The support tray 72 is initially in its lowered disengaged position as shown in FIG. 5. The container bag 20 is mounted to the mounting hooks 70 via the mount apertures 96, with the main portion 92 inserted between the side cover panel 80 and the left wall 24. This allows the container bag 20 to hang vertically along the left wall 24 of the housing 18 with the outlet portion 94 substantially being placed above the support tray 72. The outlet spout 98 is inserted into the outlet aperture 76 of the support tray 72. The loop patch 100b of the bag 20 is attached to the hook patch 60b in the support tray 72 to attach the outlet portion 94 to the support tray 72. It will be apparent that other type of connection means between the outlet portion 94 and the support tray 72 is possible.

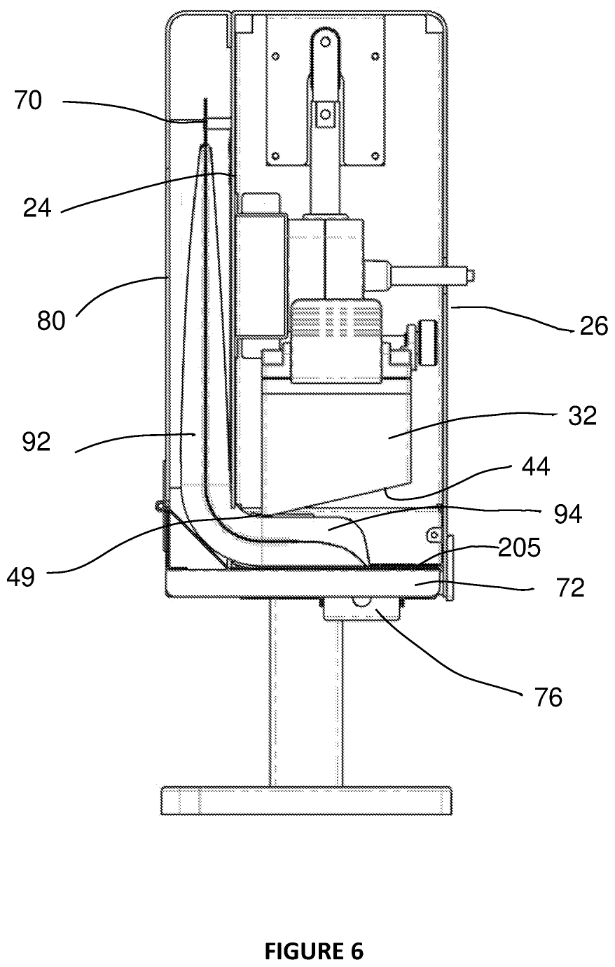

As shown in FIG. 6, the support tray 72 is then pivoted to its horizontal engaged position to lock with the right wall 26 of the housing 18 via the latch 206. The support tray 72 thus extends across the open lower portion 28 which positions the outlet portion 94 of the container bag 20 below the squeezer element 32. The main portion 92 of the container bag 20 remains to extend vertically.

It can be seen that the distal end of the outlet portion 94 of the bag 20 is clamped between the ledge 205 and the support tray 72. The ledge 205 extends up to a point close to the center of the outlet spout 98 of the bag 20. This prevents the outlet portion 94 from moving up with the squeezer element 32 during operation and also ensures the liquid in the bag 20 is directed by force from the squeezer element 32 directly to the outlet spout 98.

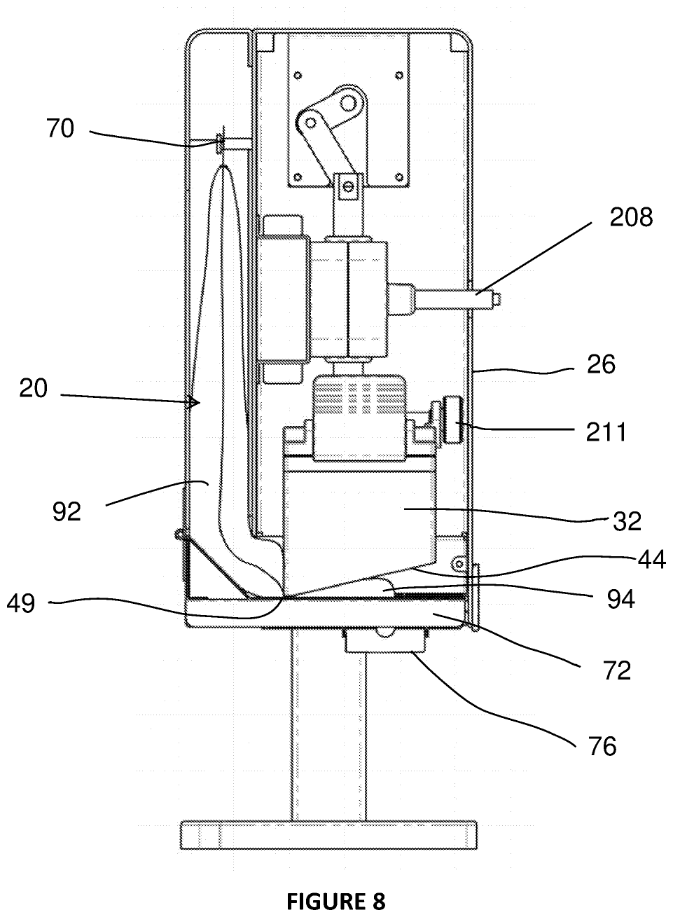

Dispensing of liquid from the container bag 20 is shown in FIGS. 6 to 9. As shown in FIGS. 6 to 8, when the squeezer element 32 starts to move downwardly, the junction line 49 of the squeezer element 32 initially engages the container bag 20 adjacent the junction between the main portion 92 and the outlet portion 94. The junction line 49 thus acts as a wedge cut-off to separate the liquids in the main portion 92 from the liquid to be expelled being the liquid in the outlet portion 94, with the support tray 72 acting as a non-moving base of the outlet portion 94. Further movement of the squeezer element 32 downwardly increases the contact between the squeezer element 32 and the container bag outlet portion 94 due to the angled surface of the lower surface 44. The contact of the squeezer element 32 with the outlet portion 94 starts from the cut-off line defined by the junction line 49 and moves in a direction towards the outlet spout 98. As the ledge 205 and the support tray 72 clamp the distal end of the outlet portion 94 up to close to the outlet spout 98, fluid in the outlet portion 94 can only travel towards and out of the outlet spout 98 from the squeezing force from the squeezer element 32. At the full downward travel position of the ram 30 and squeezer element 32 (FIG. 9), the lower surface 44 is deformed to be pressed totally flat against the support tray 72 and the ledge 205 which ensures all the liquid in the outlet portion 94 are squeezed out via the outlet spout 98.

One full turn of the motor 38 in the embodiment corresponds to one cycle of dispensing of liquid from the outlet portion 94, where the ram 30 moves from its initial lifted position, down with the squeezer element 32 to press down on the outlet portion 94, and back up to its initial lifted position. The outlet portion 94 is refilled with liquid from the main portion 92 when the ram moves up, ready for the next dispensing action as needed.

Adjustments as to the quantity of liquid to be expelled from the outlet portion 94 can be made by moving the squeezer element 32 laterally between the left wall 24 and the right wall 26 of the housing 18 which moves the squeezer element 32 laterally relative to the outlet portion 94 effectively altering the volume of the liquid in the round sleeve of the outlet portion 94 to be squeezed out. Adjustment can be made via an adjustment knob 211 of the ram 30. Rotation of the knob 211 moves the squeezer element 32 to the left or right direction as needed.

The connection means 60a and 100a between the squeezer element 30 and the outlet portion 94 connect with each other such that when the squeezer element 32 moves upwardly to its initial upper position, the upper layer of the outlet portion 94 moves upwardly relative to the lower layer thereof which creates a vacuum in the outlet portion 94 so that liquid flows consistently downwardly from the main portion 92 down to the outlet portion 94. The connection between the lower layer of the outlet portion 94 and the support tray 72 (being the patches/connection means 60b and 100b) assists with this vacuum creation. The one way valve in the outlet spout 98 assists in creating this suction vacuum in the outlet portion 94 when the ram travels up, as air is not allowed to enter the outlet portion 94 through the valve. Air entering the outlet spout 98 can reduce the volume (and precision and repeatability of dosing) of the liquid being dispense.

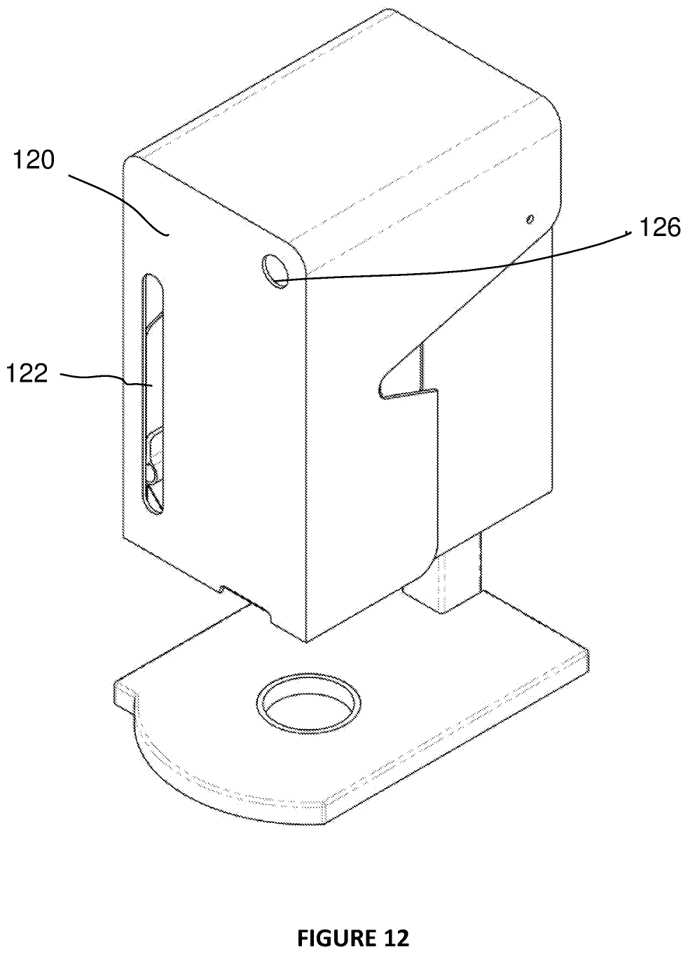

FIG. 12 shows the assembly 10 with a front cover 120. The front cover 120 includes a window 122 to allow a user to monitor the amount of liquid remaining in the main portion 92 of the bag 20. The device 10 also includes a contactless sensor 126 so that actuation of the ram 30 is initiated when the user waves a hand in front of the sensor 126. Alternatively, a sensor can be placed underneath the support tray 72 such that when a plate or container is detected under the spout 98, movement of the ram 30 is initiated. This will allow quick actuation of the device which can be particularly useful in high volume busy applications. The sensor 126 can also be replaced by a mechanical switch.

FIG. 13 shows the assembly with the front cover 120 and manual handle actuator 124 for the ram assembly 16. The ram assembly 16 in the example above is moved by a motor which performs one full revolution for each reciprocating action of the ram assembly 16 and thus each dispensing action from the outlet portion 94. The ram assembly 16 can however in this embodiment be moved by a manual handle 124 which is biased in an up position, and when moved to a down position moves the ram assembly 16 with the squeezer element 32 down to perform one dispensing action. The handle acts on the spindle 208 as a rack and pinion assembly for example to move the squeezer element 32.

Whilst preferred embodiments of the present invention have been described, it will be apparent to skilled persons that modifications can be made to the embodiments described.

The device can additionally include a heating element, for example in the space between the side cover panel 80 and the left wall 24, for heating products in the bag as needed or desired, such as high viscosity food or non-food products in the bag. The heating element for example can be silicone heater mats (also known as silicone heater pads) which are a flexible heating device made from silicone rubber.

As noted above, the position of the squeezer element 32 to the outlet portion 94 can be adjusted by moving the squeezer element 32 relative to the ram 30 for example. Another alternative can be moving the outlet portion 94 relative to the squeezer element 32 such as by moving the support tray 72 laterally relative to squeezer element 32. In either case, the position of the squeezer element 32 relative to the outlet portion 94 is adjustable for adjusting the quantity of liquid to be expelled from the outlet portion 94.

Another method of adjusting the volume of liquid dispensed per stroke includes changing the squeezer element 32 to a different shape or size squeezer element via the quick attachment clip 52.

Another possible method of adjusting the volume includes adjusting the vertical distance the ram 30 will travel downwards after cutting of the flow with the cut-off junction line 49. For example, the ram can be actuated to not travel all the way down to a fully squashed/flat position as shown in FIG. 9. In this embodiment, the motor 38 will be bi-directional and actuated to rotate part of a full rotation one way then return the other way, instead of doing one full rotation. This embodiment can also be used in applications where variable volume dispensing is desired. For example, one user may desire only a smaller volume of liquids being dispensed and another user may desire a larger volume. A control unit can be programmed to allow a user to select the volume desired. The user for example can be provided with small, medium, and large options of portions (e.g. via selection buttons or a dial) to be dispensed. A selection dial for example can indicate the volume in millilitres (mL) of the liquid to be dispensed which the user can select prior to actuation of the ram and squeezer element. The control unit will then control the amount of travel of the ram 30 with the squeezer element 32 to dispense the corresponding volume and for the ram 30 to travel back to its original raised position after dispensing. A sensor can be placed adjacent to the outlet 76 to measure the volume of liquid dispensed as a feedback/check. The control unit can then adjust the travel of the squeezer element 32 as needed in response to the feedback.

If manual handle 124 is being used, a stop formation such as a pin or rod in the cover 122 can be used to limit the downward travel of the handle 124. Markers can also be used to indicate to the user the travel/movement of the manual handle 124 needed to dispense the desired volume to allow for variable volume dispensing.

In a possible modification, the outlet spout 98 can be formed at the distal end of the outlet portion 94 with the bag held to be wholly vertically. The support tray 72 in this embodiment is vertical and the ram 30 with the squeezer element 32 is moved horizontally to actuate a squeezing pressure on the outlet portion 94.

In the above embodiment, the bag 20 can also be held with the main portion 92 at a different angle to vertical which still enables a flow down to the outlet portion 94 such as inclined downwardly.

In another possible modification, the device can include a separate cut-off means such as a movable bar to cut off liquid in the outlet portion from the remainder of the bag. The squeezer element can then have a flatter lower surface.

I claim:

1. A dispensing device for a liquids container bag having an outlet portion with an outlet spout, the device comprising:
a ram assembly having a ram with a squeezer element for applying a squeezing force to the outlet portion; and
a bag support for holding the liquids container bag with the outlet portion thereof supported adjacent the ram assembly,
wherein the squeezer element is comprised a soft resilient material which can deform when force is applied thereto but will return to its original shape when the force is removed, the squeezer element having a surface which is angled to form a cut-off portion,
wherein, during movement of the squeezer element via the ram assembly in use, the cut-off portion of the squeezer element initially engages the outlet portion, and further movement of the squeezer element increases the contact between the squeezer element surface and the outlet portion as the squeezer element is deformed to be pressed flat against the outlet portion to dispense liquid via the outlet spout.

2. (canceled)

3. The dispensing device of claim 1, wherein the squeezer element has an angled face and the cut-off portion comprises a wedge formation defined by the angled face.

4. The dispensing device of claim 1, wherein the squeezer element applies the squeezing force in a direction from the cut-off portion towards the outlet spout as the squeezer element applies the squeezing force.

5. The dispensing device of claim 1, wherein the device comprises a support tray for supporting the outlet portion, the support tray having an aperture for the outlet spout, and the squeezer element presses against the outlet portion in the support tray.

6. The dispensing device of claim 5, wherein the support tray is horizontal and the ram is adapted to be moved in the vertical axis in a linear motion such that the squeezer element presses down on the outlet portion.

7. The dispensing device of claim 6, wherein the ram is movable via an actuator in a reciprocating manner along the vertical axis.

8. The dispensing device of claim 7, wherein the actuator is a motor connected to the ram via an offset crankshaft link and a connecting rod such that one rotation of the motor translates to movement of the ram from an initial up position, down to a squeezing position, and back up to the initial up position.

9. (canceled)

10. The dispensing device of claim 1, wherein the squeezer element is shaped as a block body having an upper portion, a lower surface, a left side wall, and a right side wall, and the upper portion comprises a rigid plate which is adapted for quick connection to the ram, the lower surface being the angled surface.

11. (canceled)

12. The dispensing device of claim 5, wherein the outlet portion comprises a lower layer and an upper layer each having a connection means, and the squeezer element comprises a corresponding connection means for connecting to the upper layer, and the support tray comprises a corresponding connection means for connecting to the lower layer.

13. (canceled)

14. The dispensing device of claim 12, wherein the support tray is pivotable from lowered angled position to a horizontal support position.

15. The dispensing device of claim 14, wherein the device comprise a horizontal ledge having a lower surface which will engage an upper layer of the outlet portion of the container bag, the ledge and the support tray clamping a distal end of the outlet portion therebetween in use.

16. (canceled)

17. The dispensing device of claim 1, wherein the position of the squeezer element relative to the outlet portion is adjustable for adjusting the quantity of liquid to be expelled from the outlet portion.

18. The dispensing device of claim 1, wherein the position of the squeezer element relative to the ram is adjustable.

19. The dispensing device of claim 1, wherein the travel distance of the ram assembly is adjustable for adjusting the squeezing force applied to the outlet portion and the amount of liquid dispensed via the outlet spout.

20. The dispensing device of claim 1, wherein the device comprises a selection means for allowing the user to select the desired amount of liquid to be dispensed.

21. The dispensing device of claim 1, further comprising:
a contactless sensor for initiating the movement of the ram assembly,
wherein the sensor is disposed underneath the support tray such that when a container is detected under the spout, movement of the ram is initiated.

22. (canceled)

23. An assembly comprising:
a dispensing device according to claim 1, and
a container bag having a main portion and an extension outlet portion extending from a lower end of the main portion, the outlet portion being a narrower extension of the main portion.

24. The assembly of claim 23, wherein the dispenser bag in structure comprises two plastic layer sheets sealed at their edges, and a lower edge of the main portion is angled towards the outlet portion for directing the liquid to the outlet portion in use.

25. The assembly of claim 24, wherein the outlet portion comprises an outlet spout at the lower layer thereof and a connection means at the upper layer thereof and a lower connection means at the lower layer thereof.

26. The assembly of claim 23, wherein the outlet spout has a one way valve therein to allow one way dispensing of liquid from the container bag and prevent air or other contaminants from entering.
